(19) United States
(12) Patent Application Publication
(10) Pub. No.: US 2010/0190132 A1
(43) Pub. Date: Jul. 29, 2010

(54) ORAL IRRIGATOR TIP

(75) Inventor: Kurt M. Taylor, Fort Collins, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: Water Pik, Inc., Fort Collins, CO (US)

(21) Appl. No.: 12/361,368

(22) Filed: Jan. 28, 2009

(51) Int. Cl. A61C 17/02

(52) U.S. Cl. 433/80

(57) ABSTRACT

An oral irrigator tip for an oral irrigator with proximal extensions for removal of debris and plaque at the gum line and between teeth in addition to mechanical stimulation of gum tissue. The extension elements may be bristle clusters, posts, or arcuate structures. The oral irrigator tip may further include a tip head and a shaft portion, the shaft portion defining a fluid outlet and a fluid inlet in fluid communication with the fluid inlet. The tip head defining an opening to a cavity for housing the fluid outlet. The extension elements may be attached to the tip head and positioned about the opening.

### CROSS-REFERENCE TO RELATED APPLICATIONS

This application is related to U.S. patent application Ser. No. 11/361,749, titled “Water Jet Unit and Handle” and filed on Feb. 24, 2006, which is hereby incorporated by reference herein in its entirety.

### BACKGROUND

The present invention relates generally to oral irrigators for dental hygiene, and more particularly to a tip for an oral irrigator.

Oral irrigators have become more prevalent in daily hygiene routines. Oral irrigators may direct water, medicament, or other fluids against teeth and into interproximal spaces, thus cleaning such areas as well as aiding in removing plaque and strengthening teeth and gums. Most oral irrigator tips merely direct fluid flow to a particular spot. Few, if any, oral irrigator tips also provide an ability to mechanically remove debris and plaque from the surface of teeth, between teeth, and at the gum line as well as providing for mechanical stimulation of gum tissue.

### SUMMARY

Generally, one embodiment of an oral irrigator tip for use with an oral irrigator device has a fluid outlet and a fluid inlet in fluid communication with the outlet, and one or more extension elements for mechanically removing debris and plaque from the surface of teeth especially from interproximal surfaces between teeth. The oral irrigator tip may further include a tip head, and a shaft portion defining the fluid inlet and fluid outlet. The shaft portion may further include a nozzle defining the fluid outlet. The tip head may house the fluid outlet within a cavity defined by an outer wall of the tip head and an opening in a distal face of the tip head. The tip head may be affixed or otherwise secured to be operably joined to the shaft portion.

The extension elements may be attached to the tip head and positioned about the opening. The extension element may include bristle clusters, posts, and arcuate structures adhered or otherwise affixed to the tip head. The extension elements may be arranged in a pattern about the tip head surrounding the opening. The extension elements may be spatially-separated from each other with a separation distance greater than a smallest cross-sectional dimension of the particular extension element.

### BRIEF DESCRIPTION OF THE FIGURES

FIG. 1 is a side elevation view of an embodiment of an oral irrigator tip with a fluid passage shown in phantom.

FIG. 2 is an exploded partial side elevation view in cross-section of the oral irrigator tip of FIG. 1 showing the tip head and apex of the shaft.

FIG. 3 is an isometric view of the oral irrigator tip of FIG. 1, showing the tip head with bristled extension elements.

FIG. 4 is a front elevation view of the tip head of the oral irrigator tip of FIG. 1.

FIG. 5 is an isometric view of another embodiment of an oral irrigator tip having cylindrical flexible extension elements arranged about the nozzle.

FIG. 6 is an isometric view of a further embodiment of an oral irrigator tip having a number of arcuate, flexible extension elements arranged about the nozzle.

### DETAILED DESCRIPTION

Embodiments of oral irrigator tips for an oral irrigator device are described herein. The oral irrigator tip may have a plurality of extension elements. The extension elements may be attached to a tip head. The tip head may be connected to a shaft portion to form the oral irrigator tip. The tip head may be securedly or removably attached to the shaft portion. The tip head may have a tip head face with an opening in connection with a cavity for housing the shaft fluid outlet. The shaft fluid outlet may define a nozzle. The tip head may be removably or fixedly attached to the shaft portion. The oral irrigator tip may be inserted into the handle of an oral irrigator device.

The extension elements may be positioned proximate to the tip head to aid in the removal of debris, such as food particles, from the surface of the teeth, within the interproximal spaces of the teeth, and along the gum line as well as other surfaces and recesses within the mouth. The extension elements also aid in the mechanical stimulation of gum tissue. The extension elements may be bristle clusters, singular posts, or arcuate structures. The extension elements may be positioned about the opening in the tip head face. The extension elements may be fixed relative to the shaft portion to aid in picking or scraping debris and plaque from teeth surfaces and especially from interproximal surfaces between teeth.

The shaft portion may be straight or angled. The shaft portion may include a fluid inlet fluidly communicating with a fluid reservoir of an oral irrigator and a fluid passage for conveying fluid from a base of the shaft portion to an apex of the shaft portion. The shaft portion may include a retainer feature for joining the oral irrigator tip to the handle of an oral irrigator device. The fluid outlet may define a nozzle. The nozzle may be positioned at, below, or above the surface of the tip head face. Fluid exiting the oral irrigator tip may be used to irrigate, or otherwise clean, a user's mouth.

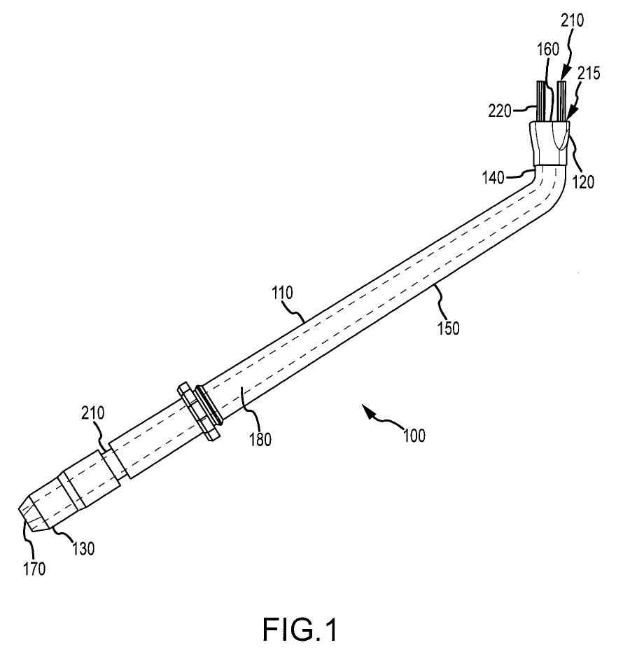

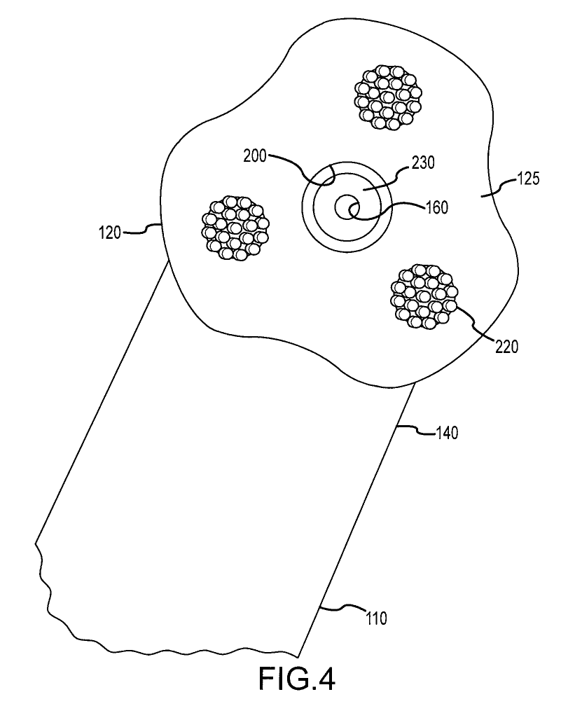

FIG. 1 depicts an example of an oral irrigator tip 100. As shown in FIG. 1, one embodiment of the oral irrigator tip 100 may take the form of a shaft portion 110 joined to a tip head 120, or other fluid outlet element or assembly of components, as shown, for example, in FIGS. 1-6. The shaft portion 110 may be in fluid communication with an oral irrigator handle (not shown). The handle may be in further fluid communication with an oral irrigator device (not shown). The tip head 120 may be attached to the shaft portion 110 to deliver a fluid stream. The fluid stream may be used to provide other dental hygiene functions.

The shaft portion 110 may be formed from plastic, metal, ceramics, or other rigid or semi-rigid materials. The shaft portion 110 may have a base 130 at one end, an apex 140 at another end, and a transitional portion 150 extending from the base 130 to the apex 140.

As shown in FIGS. 1-6, an angle may be formed in the transitional portion 150 near the apex 140 of the shaft portion 110. The angle may be approximately 60 degrees, although the angle may be greater or lesser in alternative embodiments. The angle may be formed, for example, by heat softening a straight length of the shaft portion 110 in the area to be angled and then bending the heat-softened portion into the desired angle or shape. Alternatively, the angle may be created, for example, by forming the shaft portion 110 in a mold of the desired shape and angle, by joining a bent component to a straight component, or by other known methods.

The shaft portion 110 is typically hollow and defines a fluid passage 180 from a fluid inlet 170, which may be defined in or proximate to the base 130, to a fluid outlet 160, which may be defined in or proximate to the apex 140, to form a fluid passage 180 within the shaft portion 110. In some embodiments the shaft portion 110 houses a conduit. The fluid inlet 170 of the shaft portion 110 may be fluidly connected to an oral irrigator device fluid outlet (not shown), such as a fluid outlet in an oral irrigator handle (not shown).

A retaining feature 210 may be formed on the shaft portion 110, for example, as shown in FIG. 1. The retaining feature 210 generally permits the oral irrigator tip 100 to be mated to, and retained in, an oral irrigator handle. The retaining feature 210 may be, for example, an annular groove formed about the transitional portion 150 near the base 130 and may be mated to the oral irrigator, for example, by a shelf or protuberance within the oral irrigator handle (e.g., as described in U.S. patent application Ser. No. 11/361,749), or in any other suitable manner. Alternatively, the retaining feature 210 may be a projection similarly placed. The projection may seat within a groove or depression formed within the oral irrigator handle (not shown) to connect the oral irrigator tip 100 to the oral irrigator.

In certain embodiments, the tip head 120 may be manufactured from rubber, such as a latex-free natural rubber, or other elastomeric materials being both flexible and resilient. The tip head 120, in certain alternative embodiments, may be made from a soft plastic or other suitable, non-rubber material such as a thermoplastic elastomer. In yet other embodiments, the tip head 120 may be formed of a material similar to the shaft portion 110, such as a relatively rigid plastic.

As depicted in FIGS. 1-6, the extension elements may be attached to the tip head 120. The extension elements are designed to improve cleaning of teeth, the interproximal surfaces of teeth, and the gum line. In addition the extension elements are designed to aid in cleaning in and around dental implants as well as other oral surfaces and recesses. Extension elements have a distal end 210 positioned away from the tip head 120 and a proximal end 215 at the tip head 120.

In some embodiments the extension elements may be manufactured from a variety of materials depending on the type of oral hygiene desired. In some embodiments the extension elements may be manufactured from rubber, such as a latex-free natural rubber, or other elastomeric materials being both flexible and resilient. In certain alternative embodiments, the extension elements may be made from a soft plastic or other suitable, non-rubber material such as a thermoplastic elastomer. In yet other embodiments, the extension elements may be formed of a material similar the tip head 120. In some embodiments some extension elements affixed to the tip head 120 may be made of the same material. In other embodiments the extension elements affixed to the tip head 120 may be made of different materials.

In the embodiment shown in FIGS. 1-4, the extension elements may be formed as discrete bristle clusters 220 and attached to the tip head 120. The number of individual bristles in a bristle cluster 220 as well as the dimensions of individual bristles within the bristle cluster 220 will vary depending on the type of oral hygiene desired. In an exemplary embodiment, the bristle cluster 220 may be formed by grouping about 20 individual bristles. In other embodiments the bristle cluster 220 may have fewer than 20 individual bristles per bristle cluster. In further embodiments the clusters may contain more than 20 bristles. In still further embodiments, the number of bristles 220 may vary between clusters.

The bristle clusters 220 may be positioned randomly about the tip head 120, or arranged in a pattern on the tip head 120. In some embodiments, for example as depicted in FIGS. 1-4, the bristle clusters 220 may be arranged equidistant from each other in a triangular pattern. In other embodiments the bristles 220 may be less regularly positioned about the tip head 120.

In some embodiments the bristle clusters 220 may extend beyond the tip head face 125 about 0.9 cm or greater to aid in reaching surfaces between teeth. In other embodiments the length of bristle clusters 220 are optimized to aid in cleaning interproximal surfaces, the gum line, dental implants, and to stimulate the gum tissue. In still further embodiments bristle length may be varied within the clusters and between the clusters, i.e., some clusters may have shorter bristles than others, and some bristles within a cluster may be shorter than other bristles in the same cluster.

In various embodiments, the bristle clusters 220 may also be flexible to aid in maximizing oral hygiene desired by the user. In an exemplary embodiment, the bristles may be made of nylon filaments and may be approximately 0.006 inch diameter.

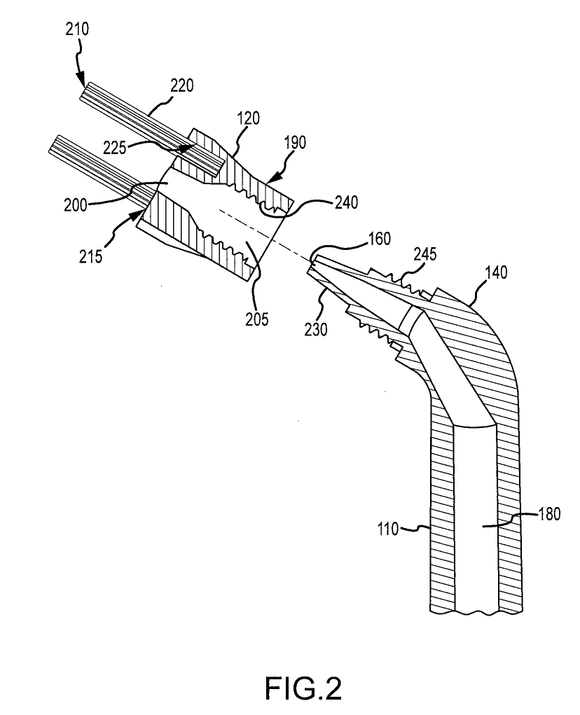

FIG. 2 shows how extension elements may be glued or otherwise affixed to the tip head 120. In this embodiment, the bristle clusters 220 are inserted into and adhered within corresponding pockets 225 in the tip head 120. In other embodiments the extension elements may be integrally molded with the tip head 120.

In various embodiments, depending on the desired type of oral hygiene, the extension elements may extend normally, or perpendicular, with respect to the tip head 120 as shown in FIGS. 1-4. In other embodiments, to optimize oral hygiene, extension elements may be angled other than normal to the tip head face 125.

FIG. 2 shows an exploded view in cross-section of the apex 140 of the shaft portion 110 and the tip head 120. In this embodiment, the tip head 120 may be axially aligned with the shaft portion 110. The tip head 120 may define a cavity 205 connected to a tip head face 125 by an opening 200 in the tip head face 125. The shaft fluid outlet 160 may be in the form of a nozzle 230. The nozzle 230 may be housed within the cavity 205 in the tip head 120, thus permitting fluid to flow along the shaft portion 110 through the fluid passage 180 from the oral irrigator device to the nozzle 230 and exit the opening 200 of the tip head 120.

The tip head 120 may be removably or fixedly joined directly to the shaft portion 110 by threading, press fitting, detent fitting, clamping, or otherwise removably joining a connector portion 190 to the shaft portion 110. In one embodiment, shown in FIG. 2, the tip head 120 is joined to the shaft portion 110 by threading the connector portion 190 onto the shaft portion 110, wherein the tip head 120 may include an internal threaded portion 240 within the cavity 205 for mating with an external threaded portion 245 of the shaft portion 110. In further threading embodiments, the tip head 120 may be externally threaded and the shaft portion 110 internally threaded. In other embodiments, the tip head 120 may be integrally formed with the shaft portion 110 by sonic welding, adhesive, or otherwise permanently joining the two portions.

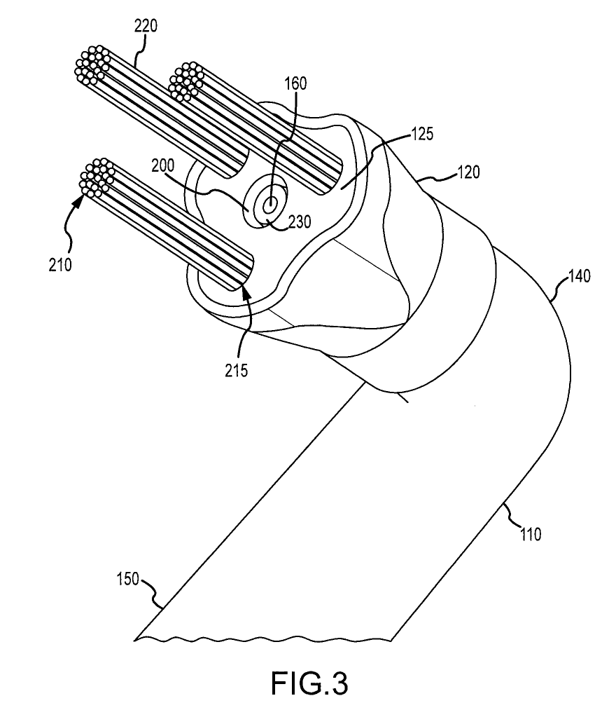

FIG. 3 shows an isometric view of the oral irrigator tip of FIG. 1 wherein the tip head 120 is affixed to the shaft portion 110. In this embodiment the fluid outlet 160 is positioned co-planar with the tip head face 125. Alternatively, the fluid outlet 160 may be positioned above or below the tip head face 125.

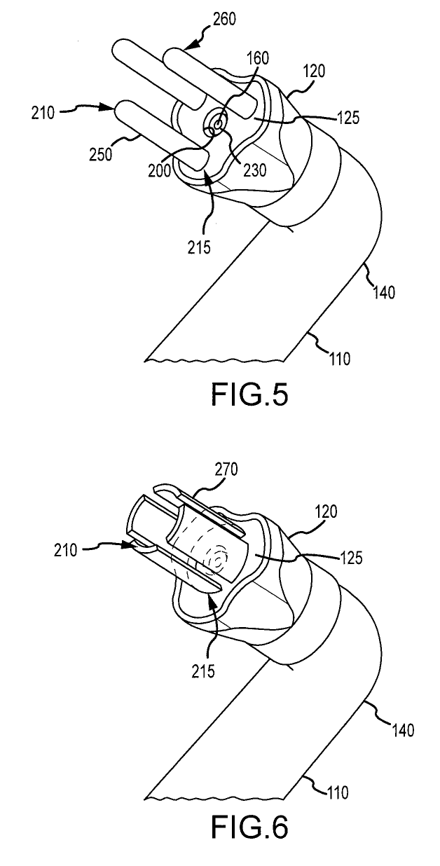

In order to maximize oral hygiene, extension elements may have various other embodiments. As depicted in FIGS. 5 and 6, the extension elements may include embodiments other than bristles 220. In one embodiment as shown, in FIG. 5, the extension elements may be one or more posts 250. The posts 250 may be adhered, sonically welded, or otherwise relatively permanently affixed to the tip head 120. The posts 250 extend normally from the tip head 120. In other embodiments, as needed to maximize oral hygiene, the posts 250 may extend from the tip head 120 other than normally.

In various embodiments, the posts 250 may be manufactured from a variety of materials. In some embodiments the posts 250 may be made of rubber, such as a latex-free natural rubber, or other elastomeric materials being both flexible and resilient. In certain alternative embodiments, the posts 250 may be made from a soft plastic or other suitable, non-rubber material such as a thermoplastic elastomer.

The posts 250 can be various shapes and lengths. For example, as shown in FIG. 5, the posts 250 may be cylindrical with a distal end 210 that is rounded. The posts 250 may also be tapered at the distal end 210 to aid in removing debris from oral surfaces.

In various embodiments the posts 250 are flexible to aid in reaching interproximally between teeth. In various embodiments the posts 250 are sufficiently long to reach interproximally between teeth. In some embodiments the posts 250 measure about 0.9 cm from the tip head face 125 to distal end 260. In other embodiments the posts are greater than 0.9 cm in length. In still further embodiments the lengths of the posts 250 may vary.

In another embodiment of extension elements, shown for example in FIG. 6, the extension elements may be arcuate structures 270 arranged around the central axial line of the tip head 120. While FIG. 6 shows one embodiment with four arcuate structures 270, other embodiments may have as few as two arcuate structures 270 attached to the tip head 120. The separation distance between arcuate structures 270 is greater than the thickness of the arcuate structures 270 to allow the arcuate structures 270 to move independently and reach interstitial spaces and recesses in the dentition. In some embodiments the arcuate structures 270 extend about 0.9 cm or greater beyond the tip head face 125 to aid in reaching surfaces between teeth.

In various embodiments the arcuate structures 270 may be manufactured from a variety of materials to maximize oral hygiene. In some embodiments the arcuate structures 270 may be made of rubber, such as latex-free natural rubber, or other elastomeric materials being both flexible and resilient. In other embodiments the arcuate structures 270 may be made from soft plastic or other non-rubber materials.

All directional references (e.g., upper, lower, upward, downward, left, right, leftward, rightward, top, bottom, above, below, inner, outer, vertical, horizontal, clockwise, and counterclockwise) are only used for identification purposes to aid the reader's understanding of the example of the invention, and do not create limitations, particularly as to the position, orientation, or use of the invention unless specifically set forth in the claims. Joinder references (e.g., attached, coupled, connected, joined, and the like) are to be construed broadly and may include intermediate members between a connection of elements and relative movement between elements. As such, joinder references do not necessarily infer that two elements are directly connected and in fixed relation to each other.

In some instances, components are described with reference to “ends” having a particular characteristic and/or being connected with another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

It will be apparent to those of ordinary skill in the art that variations and alternative embodiments may be made given the foregoing description. Such variations and alternative embodiments are accordingly considered within the scope of the present invention.

What is claimed is:

1. An oral irrigator tip for an oral irrigator for use in hydraulic and mechanical cleaning of oral surfaces and recesses comprising:
an outlet opening and an inlet opening in fluid communication with the outlet opening; and
a plurality of flexible, spatially-separated extension elements with a separation distance greater than a smallest cross-sectional dimension of the extension element; wherein the extension elements are affixed to the oral irrigator tip in proximity of the outlet opening.

2. The oral irrigator tip of claim 1 further comprising:
a shaft defining the fluid outlet and fluid inlet; and
a tip head axially aligned with and attached to the shaft, wherein the tip head further comprises:
a tip head face; and
an opening in the tip head face in communication with a cavity defined by an outer wall of the tip head, wherein the cavity houses the fluid outlet.

3. The oral irrigator tip of claim 2, wherein the extension elements are attached to the tip head face and positioned about the opening.

4. The oral irrigator tip of claim 2, wherein the extension elements extend normally from the tip head face.

5. The oral irrigator tip of claim 2, wherein:
the shaft further comprises a nozzle that defines the fluid outlet; and
the fluid outlet is positioned within the opening and co-planar with the tip head face.

6. The oral irrigator tip of claim 2, wherein:
the shaft further comprises a nozzle that defines the fluid outlet; and
the fluid outlet is positioned within the opening and above or below a surface of the tip head face.

7. An oral irrigator tip for an oral irrigator for use in hydraulic and mechanical cleaning of oral surfaces and recesses comprising:
a tip head;
the tip head further comprising:
a tip head face; and
an opening in the tip head face in communication with a cavity defined by an outer wall of the tip head; and
a plurality of bristle clusters fixed to the tip head face and positioned about the opening.

8. The oral irrigator tip of claim 7, wherein the bristle clusters are separated by at least a smallest cross-sectional dimension of the bristle cluster.

9. The oral irrigator tip of claim 7, wherein the bristle clusters comprise approximately 20 bristles.

10. The oral irrigator tip of claim 7 further comprising:
a shaft portion connected with the tip head, wherein the shaft portion defines a fluid outlet and a fluid inlet in fluid communication with the fluid outlet.

11. The oral irrigator tip of claim 10, wherein:
the shaft portion further comprises a nozzle that defines the fluid outlet; and
the nozzle is substantially positioned within the cavity in the tip head.

12. An oral irrigator tip for an oral irrigator for use in hydraulic and mechanical cleaning of oral surfaces and recesses comprising:
a tip head;
the tip head further comprising:
a tip head face;
an opening in the tip head face in communication with a cavity defined by an outer wall of the tip head; and
a plurality of posts affixed to the tip head face and positioned about the opening.

13. The oral irrigator tip of claim 12, wherein the posts are separated by at least a smallest cross-sectional dimension of the posts.

14. The oral irrigator tip of claim 12, wherein the posts are formed of elastomeric material.

15. The oral irrigator tip of claim 12, wherein the posts are cylindrical.

16. The oral irrigator tip of claim 12, further comprising:
a shaft portion connected to the tip head, wherein the shaft portion defines a fluid outlet and a fluid inlet in fluid communication with the fluid outlet.

17. The oral irrigator tip of claim 16, wherein:
the shaft portion further comprises a nozzle that defines the fluid outlet; and
the nozzle is substantially positioned within the cavity in the tip head.

18. An oral irrigator tip for an oral irrigator for use in hydraulic and mechanical cleaning of oral surfaces and recesses comprising:
a tip head;
the tip head further comprising:
a tip head face;
an opening in the tip head face in communication with a cavity defined by an outer wall of the tip head; and
a plurality of arcuate structures affixed to the tip head face and positioned about the opening.

19. The oral irrigator tip of claim 18, wherein the arcuate structures are separated by at least a smallest cross-sectional dimension of the arcuate structures.

20. The oral irrigator tip of claim 18, wherein the arcuate structures are formed of elastomeric material.

21. The oral irrigator tip of claim 18, further comprising:
a shaft portion connected to the tip head, wherein the shaft portion defines a fluid outlet and a fluid inlet in fluid communication with the fluid outlet.

22. The oral irrigator tip of claim 21, wherein:
the shaft portion further comprises a nozzle that defines the fluid outlet; and
the nozzle is substantially positioned within the cavity in the tip head.
